(19) United States
(12) Patent Application Publication
(10) Pub. No.: US 2009/0021645 A1
(43) Pub. Date: Jan. 22, 2009

(54) Video signal processing device, video signal processing method and video signal processing program

(75) Inventor: Kazuyoshi Hayashi, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/214,812

(22) Filed: Jun. 23, 2008

(30) Foreign Application Priority Data
Jul. 4, 2007 (JP) P2007-176650

(51) Int. Cl. H04N 5/00

(52) U.S. Cl. 348/607

(57) ABSTRACT

A video signal processing device for compressing input video and transmitting compressed video data onto a network, the video signal processing device including a compression section configured to compress the video, and a noise reduction section configured to reduce noise in video data by a predetermined amount of noise reduction according to the size of the video data transmitted onto the network.

### CROSS REFERENCES TO RELATED APPLICATIONS

The present invention contains subject matter related to Japanese Patent Application JP 2007-176650 filed with the Japan Patent Office on Jul. 4, 2007, the entire contents of which being incorporated herein by reference.

### BACKGROUND OF THE INVENTION

1. Field of the Invention

The present invention relates to a video signal processing device, a video signal processing method and a video signal processing program, and relates, for example, to a video signal processing device, a video signal processing method and a video signal processing program for providing reduced noise in input video data and smaller transmission data size which are suitable for application to a monitoring camera system.

2. Description of the Related Art

Previously, so-called analog camera systems were in common use as monitoring camera systems. Each of such systems has a video tape recorder or other video recording device connected to a camera with a signal line so that the video signal captured by the camera is supplied to the video recording device via the signal line for recording. However, recent years have seen increasing popularity of so-called IP (Internet Protocol) camera systems as a result of the widespread use of the Internet. In such camera systems, the video data captured by the camera is transmitted via a network to a remotely located computer for recording to a video recording device such as a hard disk device (storage) which is connected to the computer.

Using the IP technology as is used in the IP camera systems makes it possible to remotely monitor the video captured by a camera and build a large-scale system.

The JPEG and MPEG compression schemes, common for other applications as well as for monitoring camera, are the mainstream compression schemes (codecs) for IP transmission adapted to transmit video data over an IP network. Designed for compression of still images, the JPEG (Joint Photographic Experts Group) scheme is effective even at a low frame rate. Designed for compression of moving images, the MPEG (Moving Picture Experts Group) scheme permits compression at a higher rate as compared to JPEG and other still image compression schemes.

FIG. 1 is a block diagram illustrating an example of a prior art monitoring camera system (IP output). A monitoring camera 1 includes a lens 2 adapted to collect light reflected by the subject. The same camera 1 further includes a CCD (Charge Coupled Device) or CMOS (Complementary Metal Oxide Semiconductor) sensor 3 adapted to detect the image formed by light collected by the lens 2. The same camera 1 still further includes a signal processing section 4 adapted to handle signal processing and a compression/decompression device (codec) 5 adapted to compress the image data which has been processed by the signal processing section 4. The same camera 1 still further includes a CPU 6 adapted to set a compression rate of the codec 5, receive the compressed data and control the transmission thereof onto a network and other components.

The video signal for the image captured by the CCD or CMOS sensor 3 is supplied to the signal processing section 4 for conversion into digital form. This data is supplied to the codec 5. The image data compressed by the codec 5 is supplied to the CPU 6.

The CPU 6 performs conversion and other processes of the compressed data from the codec 5 for transmission onto the network. At this time, the CPU 6 supplies a parameter indicating a compression rate to the codec 5 so that the transmission data size specified, for example, by the user is achieved. In response to the parameter indicating a compression rate from the CPU 6, the codec 5 changes the setting for the quantization step. Then, the codec 5 proceeds with the compression based on the set quantization step.

The codec 5 shown in FIG. 1 will be described in detail with reference to FIG. 2. FIG. 2 is a block diagram illustrating the basic function of the codec 5 adapted to compress the input image using the JPEG scheme. In the same figure, the input image (normally YUV color space in 4:1:1 or other format) is transformed using DCT (Discrete Cosine Transform) into a frequency range for every 8×8 pixels by a DCT 51 and supplied to a quantizer 52.

Next, the quantizer 52 reduces the frequency range information (factor) transformed by the DCT 51 according to a preset quantization table 53. The quantization level from the quantizer 52 is entropy coded by an entropy coder 54 using Huffman codes and then output as compressed image data.

To control the compression rate, the output factor of the DCT 51 is reduced using a step size suitable for the set compression rate. If the input image contains frequency components spanning a wide spectrum of frequencies, the output factor spreads over a wide range, resulting in degraded image quality unless the step size is reduced.

For example, if the input image contains frequency components spanning a narrow spectrum of frequencies, the range of the DCT factor will be narrow to match the narrow spectrum. Therefore, even if the step size is set small (compression rate is reduced), the amount of compressed data will be small. This arises from the fact that the range of the DCT factor is originally small. That is, the smaller the step size, the larger the amount of data. However, if the frequency components of the input image spread over a wide range of frequencies, the image quality will be degraded unless the step size is reduced.

The fact that the frequency components of the input image spread over a wide range of frequencies means that the input image contains a variety of fine patterns. Conversely, if the input image is monochrome or contains mild changes, the frequency components spread only over a narrow range. On the other hand, if the input image contains a number of noise components, the frequency components spread over a wide range as with the input image having a variety of fine patterns.

The JPEG scheme has been described up to this point. However, the I-picture is compressed using a DCT in the MPEG scheme similarly as in the JPEG scheme. As a result, similar tendencies can be observed in the MPEG scheme.

On the other hand, some video signal processing devices operable to adaptively reduce noise components in a video signal can detect the amount of noise in the input video signal. The devices adaptively suppress the noise components in the video signal according to the amount of noise and subjects the resultant video signal to compression code processing, thus providing a high-quality reproduced image (refer, for example, Japanese Patent Laid-open No. 2005-20193, which is hereinafter referred to as Patent Document 1).

### SUMMARY OF THE INVENTION

Incidentally, a monitoring camera system 1 configured as described above (FIGS. 1 and 2) is facing the challenge of increasing storage capacity required to respond to increasing transmission data size (bandwidth) as a result of the growth in scale of the system. Among the possible ways to ensure reduced transmission data size and storage capacity would be compression at a higher compression rate, frame rate reduction and image size reduction. The compression at a higher compression rate involves several problems, including lower image sharpness and deteriorated visibility resulting from block noise and false color. This makes it impossible to achieve data compression at an exceedingly high compression rate. In particular, an image superposed with noise components will suffer quality degradation if compressed at higher compression rates. This can be observed particularly in an image captured at night.

The frame rate reduction consists of reducing the frame rate of images captured and transmitted normally at 30 frames per second down to 15 frames per second or less. Although dependent upon the subject, this method can provide a reduced frame rate within the limits of not adversely affecting the detection of human motions.

The reduction of image resolution leads to poor visibility of small objects, fine patterns and others in the image. However, this method, also dependent upon the subject, can be used to reduce the transmission data size within the limits of not adversely affecting the detection of human motions.

Each of these transmission data size reduction approaches is not used alone. Instead, they are often used in combination until the required reduction is achieved. Moreover, if the image quality is the same, the higher the compression rate and the smaller the transmission data size, the more preferred the approach.

Further, the difference from the preceding or following frame is quantized for B- and P-pictures in the MPEG scheme. Therefore, if noise is superposed on a frame image, there will be a larger frame-to-frame difference as this noise has no correlation with image patterns. This will lead to a larger transmission data size as compared with the image with minimal noise if the same level of image quality is needed.

As mentioned earlier, on the other hand, data compression approaches other than codec, namely, frame rate reduction and image resolution reduction, may be used in combination. However, all of these approaches are selected according to factors including actual configuration of the monitoring camera system, monitored target and required accuracy. As a result, these data reduction parameters for the monitoring camera system cannot be determined in a standardized manner. Therefore, these parameters must be changeable by the user and installer. However, these parameters could not have been changed while at the same time suppressing the deterioration in visibility of the monitored target.

On the other hand, the technique disclosed in the invention of Patent Document 1 adaptively suppresses noise components in an input video signal according to the amount of noise in the same signal for compression coding, thus providing a high-quality reproduced image. However, this technique cannot suppress the deterioration in visibility while at the same time providing reduced transmission data size.

The present invention has been made in light of the foregoing problems to propose a monitoring camera system capable of reducing the deterioration in visibility while at the same time providing reduced transmission data size.

To solve the foregoing problems, the present invention includes a compression section configured to compress video and a noise reduction section configured to reduce noise in video data by a predetermined amount according to the size of the video data transmitted onto the network. The present invention can provide reduced noise according to the transmission data size, thus suppressing the deterioration in visibility at a low bit rate.

The present invention can realize a video signal processing device, a video signal processing method and a video signal processing program capable of suppressing visibility deterioration caused by image quality degradation irrespective of the data size transmitted onto a network.

### BRIEF DESCRIPTION OF THE DRAWINGS

FIG. 1 is a block diagram illustrating a configuration example of an existing monitoring camera system;

FIG. 2 is a basic block diagram illustrating JPEG compression steps performed by a codec of the monitoring camera system;

FIG. 3 is a block diagram illustrating a configuration example of the monitoring camera system according to an embodiment of the present invention;

FIG. 4 is a diagram illustrating noise reduction steps performed by a signal processing section;

FIG. 5 is a diagram illustrating an example of 3×3 smoothing;

FIG. 6 is a diagram illustrating noise reduction steps including a time axis;

FIG. 7 is a diagram illustrating noise reduction steps performed based on a plurality of frames on the time axis;

FIG. 8 is a diagram illustrating compression steps performed for all frames;

FIG. 9 is a diagram illustrating compression steps for reducing the frame rate to 1/3;

FIG. 10 is a diagram illustrating steps for reducing noise in unthinned frames during a time period when no compression is performed while at the same time reducing the data size by reducing the frame rate to 1/3;

FIG. 11 is a flowchart illustrating steps performed by a parameter setting section;

FIG. 12 is a flowchart illustrating steps performed by a signal processing section;

FIG. 13 is a flowchart illustrating steps performed by an image compression section;

FIG. 14 is a flowchart illustrating steps performed by a network processing section; and

FIG. 15 is a flowchart illustrating steps performed by a noise reduction section.

### DETAILED DESCRIPTION OF THE PREFERRED EMBODIMENT

An embodiment of the present invention will be described in detail below with reference to the accompanying drawings.

### (1) Overall Configuration of the Monitoring Camera System

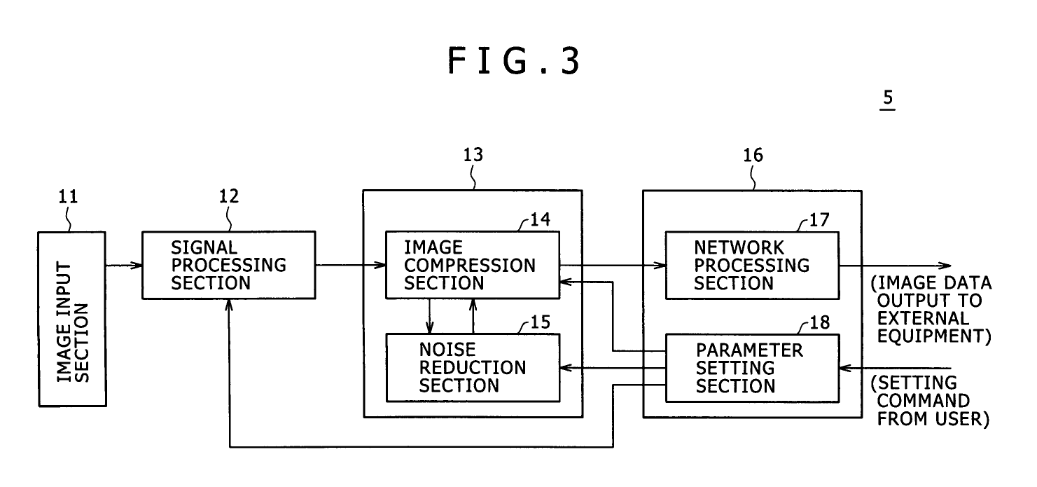

As illustrated in FIG. 3, a monitoring camera system 10 according to the present embodiment includes an image input section 11, signal processing section 12, codec 13 and CPU 16. The image input section 11 includes components which are not shown such as a lens and CCD (Charge Coupled Device) or CMOS (Complementary Metal Oxide Semiconductor) sensor. The same section 11 is connected to the signal processing section 12. The same section 12 is connected to the codec 13. The codec 13 is connected to the CPU 16.

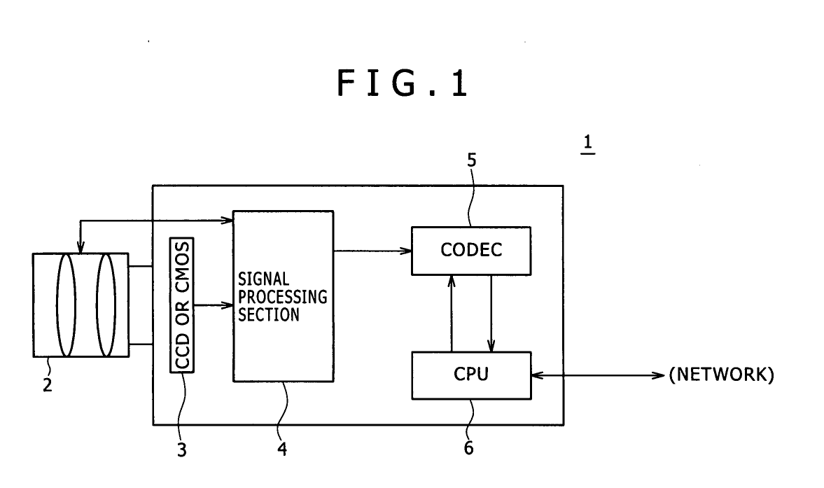

The image input section 11 corresponds to the lens 2 and CCD or CMOS sensor 3 in FIG. 1. The same section 11 supplies image data for the captured image to the signal processing section 12. The signal processing section 12 corresponds to the signal processing section 4 in FIG. 1. The same section 12 converts the image data from the image input section 11 into digital form and outputs this digital image data.

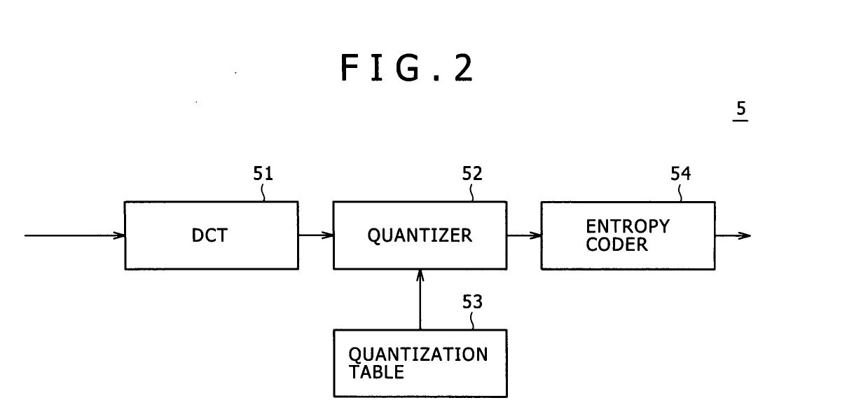

The codec 13 includes an image compression section 14 and a noise reduction section 15 which include a DSP (Digital Signal Processor) and other components. These sections will be described later. The image compression section 14 compresses the image data from the signal processing section 12 using DCT (Discrete Cosine Transform). The noise reduction section 15 reduces noise in the image data from the signal processing section 12. As with the codec 5 in FIG. 1, the image compression section 14 performs MPEG compression as well as JPEG compression described above with reference to FIG. 2.

The CPU 16 corresponds to the CPU 6 in FIG. 1 and includes a network processing section 17 and parameter setting section 18. The network processing section 17 converts the compressed image data supplied from the image compression section 14 into a data format suitable for transmission onto the network. The parameter setting section 18 supplies a parameter (setting) adapted to specify a compression rate to the image compression section 14. The same section 18 also supplies a parameter (setting) adapted to specify an amount of noise reduction to the noise reduction section 15. The same section 18 also supplies a parameter (setting) adapted to specify an amount of noise reduction to the signal processing section 12.

As described above, the image data flow in the present embodiment is the same as that in the example of the existing system shown in FIG. 1. However, the present embodiment differs from the existing example in that the CPU 16 can specify an amount of noise reduction to the signal processing section 12, the image compression section 14 and the noise reduction section 15 using a parameter.

This additional process of specifying an amount of noise reduction using a parameter makes it possible for the signal processing section 12 and the noise reduction section 15 to provide reduced noise according to the specified transmission data size (data size per frame and frame rate).

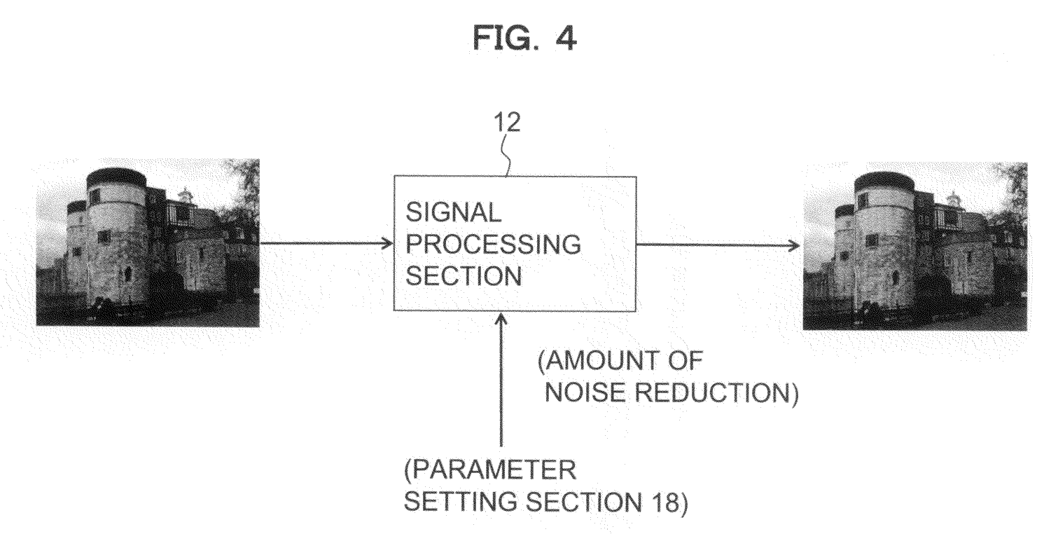

FIG. 4 illustrates noise reduction steps performed by the signal processing section 12 based on the amount of noise reduction specified using a parameter. The image data input from the image input section 11 is subjected to noise reduction in the signal processing section 12 first and then supplied to the codec 13.

The amount of noise reduction can be changed, for example, by specifying ‘n’ in n×n smoothing (n: arbitrary natural number, ×: multiplication). This smoothing process replaces a pixel of interest by the average of all of n×n pixels made up of the pixel of interest and surrounding pixels. This smoothing technique is popular in simple processes.

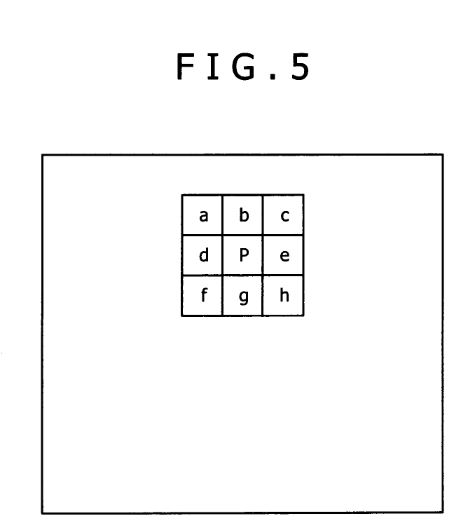

FIG. 5 illustrates an example of 3×3 smoothing. The value of a pixel P of interest (which includes noise components) is replaced by the average of the pixel P of interest and its surrounding pixels ‘a’, ‘b’, ‘c’, ‘d’, ‘e’, ‘f’, ‘g’ and ‘h.’ Assuming, for example, that the value of the pixel P (brightness) is 225 and the values of the surrounding pixels are all 0, the value of the pixel P will be 25 (=(225+0+0+0+0+0+0+0+0)÷9).

This value of n is set to 1, for example, for the maximum transmission data size and increased to 2, 3 and so on according to the reduction of data size. As a result, the larger the value of n, the more reduced the high frequency components are. This provides a reduced quantized data size. If the original quantized data size is small, the quantized data will not degrade much when compressed. This keeps the degradation caused by high frequency noise at a high compression rate to a minimum.

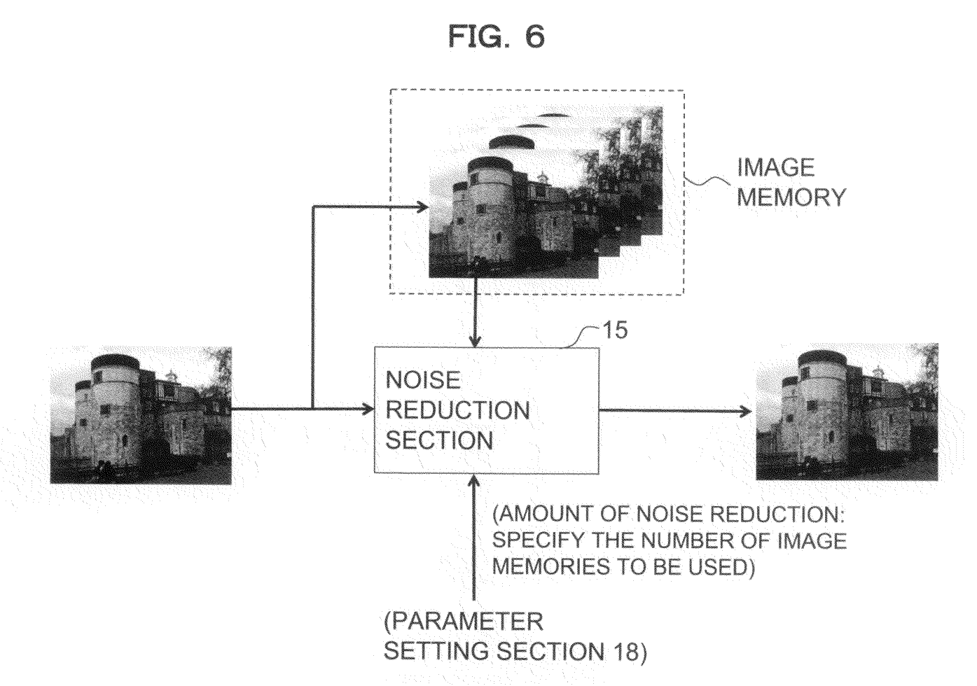

To reduce the frame rate, an unshown image memory is incorporated in or provided outside the codec 13 as illustrated in FIG. 6. Further, the image data for each of the frames stored in the image memory is used according to the number of frames reduced. This makes it possible for the noise reduction section 15 to reduce noise in the image data of the unthinned frames using the technique that best suits the frame rate.

A median filter can be used, for example, as one of techniques to reduce noise. A median filter sorts (rearranges) N data strings (N: natural number) and selects the median thereof. This filter is extremely effective in reducing sporadic noise.

Therefore, if the frame rate is maximal, N is set, for example, to 1. To reduce the frame rate down to 1/2 or 1/3, N is set, for example, to 3. To reduce the frame rate down to 1/4 or 1/5, N is set, for example, to 5. This ensures reduced sporadic noise at low frame rates thanks to noise reduction using a plurality of frames before and after the image of interest instead of simply thinning that image as in the prior art. As a result, image data can be transmitted at a lower bit rate or at a higher quality if the bit rate is the same.

The present embodiment is significantly advantageous in reducing noise along the time axis particularly in MPEG compression which achieves high compression rate using a difference along the time axis.

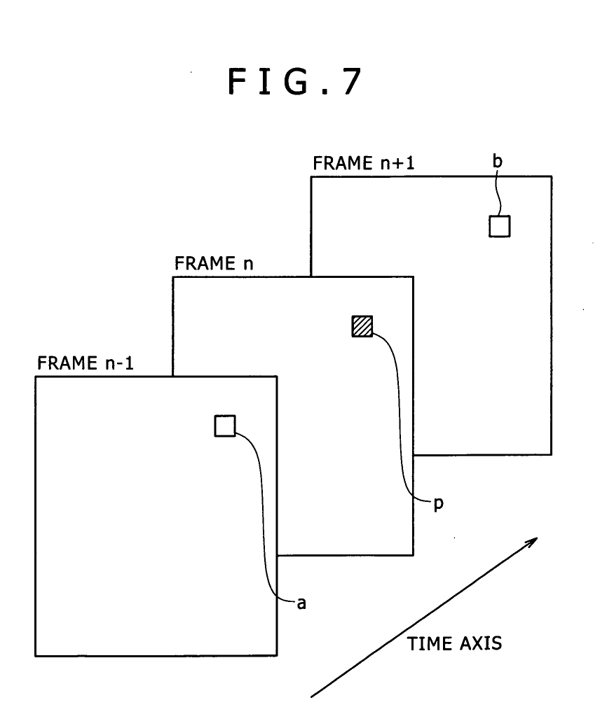

FIG. 7 illustrates noise reduction steps performed based on a plurality of frames on the time axis. In this example, N is 3. For example, we suppose that the given pixel P in a frame n contains a noise component. Then, the value of the pixel ‘a’ located at the same position in an immediately preceding frame (n−1) and that of the pixel ‘b’ located at the same position in an immediately succeeding frame (n+1) along the time axis are rearranged so that the median pixel value is used as the value of the pixel P. This provides a reduced noise component. For example, if the value of the pixel P is 255 and the values of the pixels ‘a’ and ‘b’ are both 0, then the value of the pixel P will be 0. Thus, the noise component can be eliminated using a plurality of frames along the time axis. The frames adjacent to the frame n are stored in the image memory. Therefore, image data of necessary frames can be read from the same memory.

The above noise reduction process requires a new piece of hardware. However, this process may not be performed if image data is transmitted at high quality. That is, the higher the compression rate, the more noise reduction is required. At a lower frame rate, or at a lower image resolution for a smaller data size, on the other hand, there is only a smaller amount of data compression (required by the image compression section 14).

Previously, the process handled by the image compression section 14 was often implemented by a dedicated circuit. Recent years have seen increasing incorporation of a compression algorithm using a general-purpose CPU or programmable DSP as a result of improvement in CPU performance.

Also in the present embodiment, the codec 13 includes a DSP. As described above, the amount of arithmetic required for noise reduction handled by the noise reduction section 15 of the codec 13 is proportional to the compression rate. In contrast, the amount of arithmetic required for image compression handled by the image compression section 14 of the codec 13 is inversely proportional to the compression rate. As a result, if these processes are handled sequentially along the time axis using a general-purpose CPU or DSP, noise reduction can be achieved according to the data reduction amount without need for additional piece of hardware.

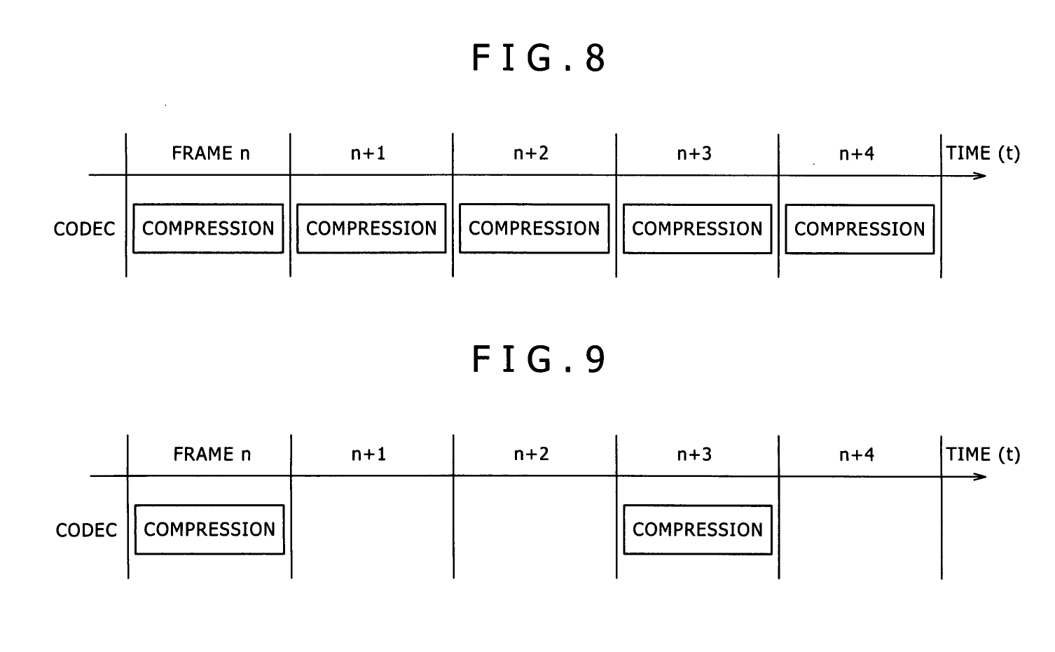

FIG. 8 illustrates compression steps performed for all frames. All frames are compressed successively starting with the frame n. FIG. 9 illustrates compression steps for reducing the frame rate to 1/3. The frames n, (n+3), (n+6) and so on are compressed successively.

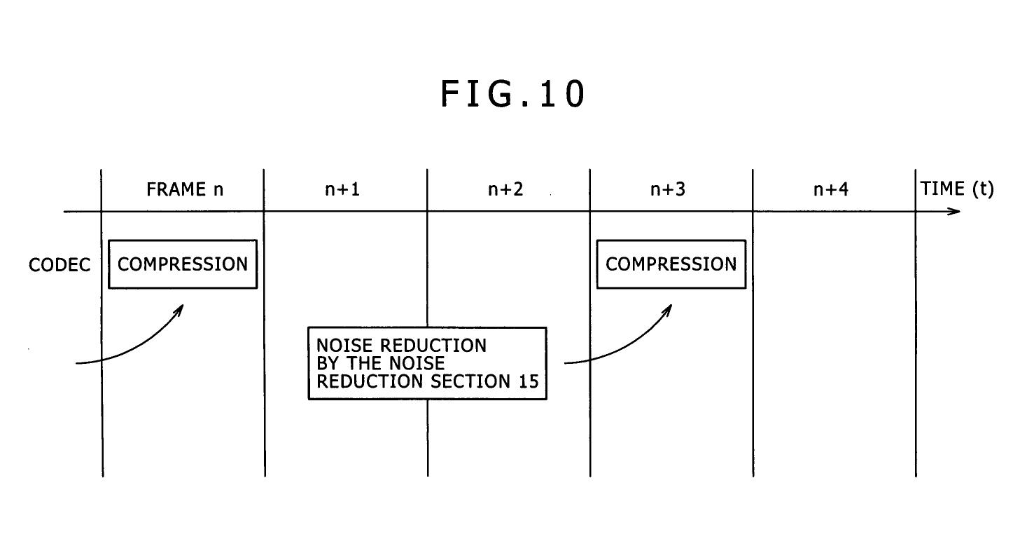

FIG. 10 illustrates steps for reducing noise in unthinned frames during a time period when no compression is performed while at the same time reducing the data size by reducing the frame rate to 1/3. In this example, the noise reduction section 15 performs noise reduction of the frame (n+3) during a period of time from the completion of the compression of the frame n to the beginning of the compression of the frame (n+3) by the image compression section 14.

This noise reduction is carried out by the noise reduction section 15 of the codec 13 based on a plurality of frames on the time axis. If noise is reduced based on a plurality of frames on the time axis, several frames before and after the frame to be compressed must be stored in the image memory.

In the example shown in FIG. 10, when the frame (n+3) is compressed, the frames (n+1) to (n+5) must be stored in the image memory. Therefore, the image compression section 14 performs its compression based on the frames stored in the image memory.

The aforementioned functionality and configuration allow for optimal noise reduction according to the data reduction amount while at the same time preventing an increase in circuit scale. This ensures reduced recording and transmission data sizes to respond to the problem facing IP-based monitoring camera systems, namely, growing data sizes, thus providing improved visibility.

With the advance of data compression techniques, it is becoming increasingly common to execute a compression algorithm with a CPU or DSP or handle part of the processes of the algorithm with a CPU rather than using a fully hardware-based compression device. The present embodiment provides, in the case of the above hardware configuration, reduced data sizes while at the same time preventing an increase in hardware scale by adaptively reducing noise with a CPU or DSP.

Previously, the same noise reduction was performed, irrespective of the frame rate or transmission data size, or a noise reduction was performed which was suitable for the highest image quality. As a result, noise could not be reduced effectively at low image quality. The present embodiment eliminates the above problem, allowing for optimal noise reduction according to the transmission data size and thereby providing improved visibility and reduced transmission and recording data sizes.

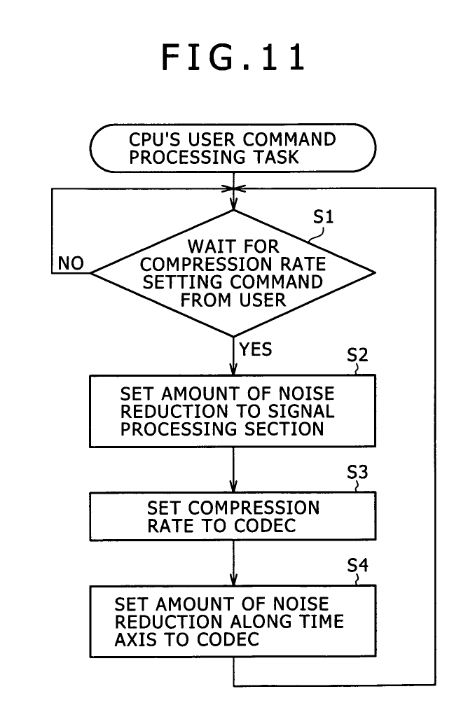

FIG. 11 is a flowchart illustrating steps performed by the parameter setting section 18 for setting a compression rate and amount of noise reduction. In step S1, an unshown operation section is operated by the user, and the parameter setting section 18 determines whether or not the user command adapted to set a compression rate has been entered. If not, the same section 18 will repeat the process step in step S1 to wait for the command. On the other hand, when the same section 18 determines that the command has been entered, the process will proceed to step S2.

In step S2, the parameter setting section 18 sets an amount of noise reduction to the signal processing section 12 based on the compression rate that has been set. Next in step S3, the same section 18 sets the compression rate to the image compression section 14 of the codec 13. Next in step S4, the same section sets an amount of noise reduction along the time axis to the noise reduction section 15 of the codec 13 based on the compression rate set in step 53. The parameter setting section 18 determines an amount of noise reduction based on the compression rate by a predetermined method. However, a table may be stored in advance in an unshown memory. The table contains amounts of noise reduction and associated compression rates. Thereafter, the process will return to step S1 to repeat the steps from step S1 onward. A compression rate and amount of noise reduction are set as described above.

A description will be given next of how an amount of noise reduction is set based on a compression rate. An amount of noise reduction is set based on a compression rate as follows. That is, if noise is reduced with a two-dimensional Gaussian filter, the following formula is the two-dimensional Gaussian function:

$$\begin{matrix}[ Formula 1 ] & \\ W ( x , y ) = {e}^{\frac{( {x}^{2} + {y}^{2} )}{2 {σ}^{2}}} & ( 1 )\end{matrix}$$

Noise can be reduced to a greater extent by setting σ to a larger value according to the compression rate.

It should be noted that a Gaussian filter can be calculated by the following formula (2):

$$\begin{matrix}[ Formula 2 ] & \\ {I}^{′} ( x , y ) = \frac{1}{C} {\sum }_{k = - σ}^{σ} {\sum }_{l = - σ}^{σ} w ( k \cdot l ) \times I ( x + k , y + l ) & ( 2 ) \\ [ Formula 3 ] & \\ where \\ C = {\sum }_{k = - σ}^{σ} {\sum }_{l = - σ}^{σ} w ( k , l ) & \end{matrix}$$

I: Pixel brightness level
W: Weight based on the Gaussian distribution

### σ: Dispersion

k,l: Offset coordinates of neighboring pixels(3)

If a compression rate Rate is specified, for example, from formulas (1) to (3), the amount of noise reduction can be determined by taking σ as a function of the Rate as shown below in formula (4).

[Formula 4]

σ=f(Rate) (4)

This function can be determined based on the characteristics of the codec. Alternatively, a table may be prepared in advance which contains a σ value calculated for each of the compression rates Rate so that the σ value can be determined according to the compression rate Rate by referring to the table at the time of compression.

TABLE 1
Examples of Compression Rate and σ Settings

| Compression rate Rate | σ |
|---|---|
| 90% | 1.0 |
| 50% | 2.0 |
| 30% | 3.0 |

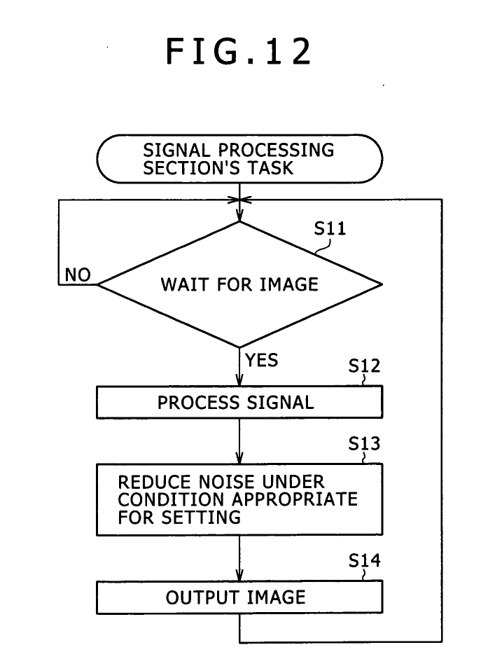

FIG. 12 is a flowchart illustrating signal processing steps performed by the signal processing section 12. In step S11, the signal processing section 12 determines whether or not an image signal has been supplied from the image input section 11. If not, the signal processing section 12 will repeat the process in step S11 to wait for an image. On the other hand, when the same section 11 determines that an image has been supplied from the image input section 11, the process will proceed to step S12.

In step S12, signal processing converts the image signal from the image input section 11 into digital form. Next in step S13, noise is reduced in the image data for the image signal from the image input section 11 based on the preset condition (amount of noise reduction). Next in step S14, the image data with reduced noise as a result of noise reduction is supplied to the codec 13.

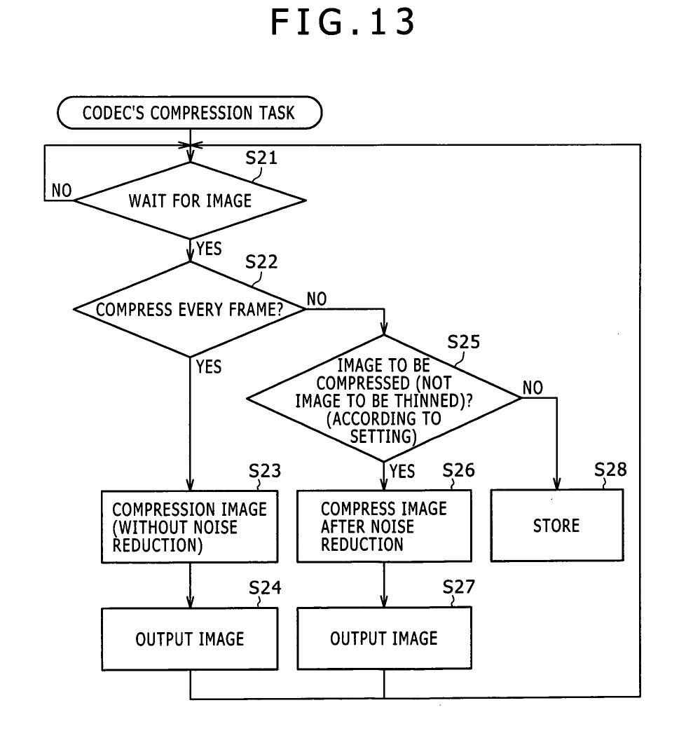

FIG. 13 is a flowchart illustrating image compression steps performed by the codec 13. In step S21, the codec 13 determines whether the image data has been supplied from the signal processing section 12. If not, the codec 13 will repeat the process in step S21 to wait for the image data. On the other hand, when the codec 13 determines that the image data has been supplied from the signal processing section 12, the process will proceed to step S22.

In step S22, the codec determines whether or not to compress every frame. That is, the codec 13 determines whether or not to compress all frames of the image data without noise reduction. This determination is made based on the compression rate and amount of noise reduction specified by the user command in FIG. 11.

If the codec 13 determines that it will compress every frame of the image data, the process will proceed to step S23 where the image compression section 14 compresses the image data without noise reduction. Thereafter, the resultant image data is supplied to the CPU 16 in step S24.

On the other hand, in step S22, when the codec 13 determines that it will not compress every frame, the process will proceed to step S25 where the codec 13 determines whether or not the image data from the signal processing section 12 is image data of a frame to be compressed. That is, the codec 13 determines whether or not the image data is image data of a frame which need not be thinned. If not, the process will proceed to step S28 where the image data is stored in the image memory.

On the other hand, when the image data is image data of a frame to be compressed (frame which need not be thinned), the process will proceed to step S26 where the image data of the frame undergoes noise reduction by the noise reduction section 15, followed by compression by the image compression section 14. Thereafter, the image data of the frame, which has undergone noise reduction and image compression, is supplied to the CPU 16 in step S27.

At the completion of the process step in step S24, S27 or S28, the process will return to step S21 and the steps from step S21 onward will be repeated. Noise reduction and image compression are handled by the codec 13 as described above.

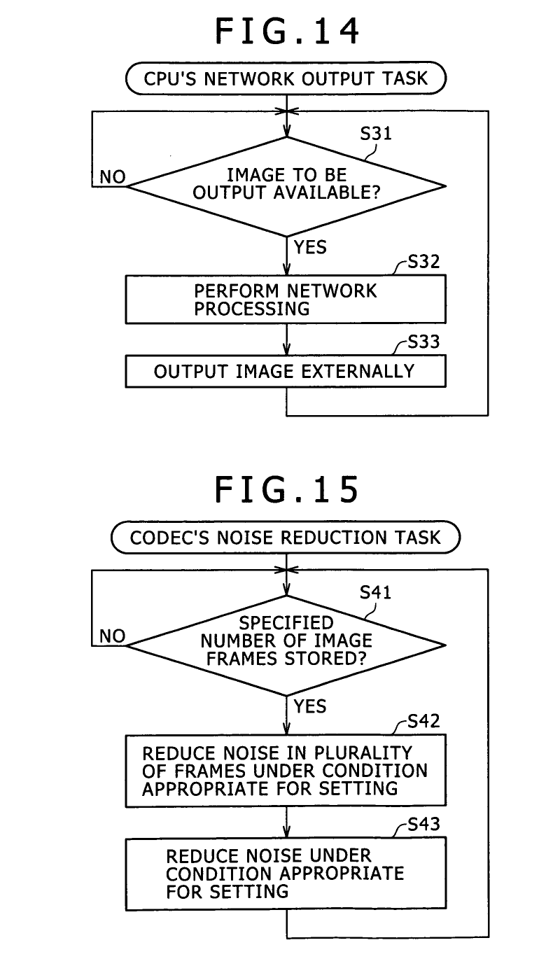

FIG. 14 is a flowchart illustrating steps performed by the network processing section 17 to transmit the image data which has undergone noise reduction and compression by the CPU 16 onto the network. In step S31, the network processing section 17 determines whether or not image data to be transmitted onto the network is available. If not, the same section 17 will repeat the process step in step S31.

On the other hand, when the same section 17 determines that image data to be transmitted onto the network is available, the process will proceed to step S32 where predetermined network processing is performed. Thereafter, the process will proceed to step S33 where the image data is transmitted onto the network.

FIG. 15 is a flowchart illustrating noise reduction steps performed by the noise reduction section 15 of the codec 13. In step S41, the noise reduction section 15 determines whether or not the specified number of image data frames is stored in the image memory. Letting the frame count be denoted by N, N=3, for example, to reduce the frame rate down to 1/2 or 1/3. N=5, for example, to reduce the frame rate down to 1/4 or 1/5. Therefore, this value N corresponds to the specified frame count.

In step S41, if the noise reduction section 15 determines that the specified number of image data frames has yet to be stored in the image memory, the same section 15 will repeat the process step in step S41. On the other hand, when the same section 15 determines that the specified number of image data frames is stored in the image memory, the process will proceed to step S42.

In step S42, the noise reduction section 15 performs noise reduction based on a plurality of frames on the time axis stored in the image memory under the condition (e.g., amount of noise reduction) appropriate for the setting.

Next in step S43, the noise reduction section 15 supplies the image data with reduced noise as a result of noise reduction to the CPU 16.

### (2) Operation and Effect

In the above configuration, the image processing section 12 converts the image signal from the image input section 11 into the image data in digital form. At the same time, the same section 12 reduces noise in the image data by smoothing or other technique. This noise reduction is performed according to the amount of noise reduction specified by the compression rate or noise reduction amount setting which has been set by the parameter setting section 18 according to the user command. Thereafter the image processing section 12 supplies the resultant to the codec 13.

The image compression section 14 of the codec 13 subjects the image data supplied from the image processing section 12 to compression. The same section 14 compresses the image data of the frames to be compressed using DCT or other technique based on the compression rate set by the parameter setting section 18. That is, if some frames are thinned as a result of frame rate reduction, the image data of those frames to be thinned is stored in the image memory. The image compression section 14 compresses the image data of those frames to be compressed. The same section 14 supplies the image data of the compressed frames to the CPU 16.

The noise reduction section 15 of the codec 13 reduces noise in the image data of those frames to be compressed based on a plurality of frames on the time axis. As a result, the image memory stores the image data of those frames which were not subject to compression and therefore were thinned for frame rate reduction. The noise reduction section 15 reads, as appropriate, the image data of those frames that requires noise reduction from the image memory.

The image compression section 14 of the codec 13 compresses the image data which has undergone noise reduction by the noise reduction section 15. Therefore, the image data is compressed after the noise reduction. If the noise reduction is performed based on a plurality of frames on the time axis, a plurality of necessary frames on the time axis are stored in the image memory first. Then, noise is reduced in the image data of those frames which will not be thinned and therefore will be compressed, followed by compression.

The image data which has undergone noise reduction and compression is supplied to the CPU 16. Then, the data is converted by the network processing section 17 for transmission onto the network. After the conversion, the data is transmitted onto the network.

The above configuration permits the user to specify at least either a compression rate or amount of noise reduction using a command, thus providing noise reduction according to the transmission size of the image data. For example, when the user specifies a compression rate, the parameter setting section 18 determines the amount of data reduction by a predetermined method according to the specified compression rate and sets the amount of data reduction to the signal processing section 12 and the noise reduction section 15.

For example, the amount of noise reduction can be adjusted according to the frame rate. More specifically, the amount of noise reduction is increased with decreasing frame rate, thus keeping the image degradation to a minimum. Further, the amount of noise reduction can be adjusted according to the transmission data size. More specifically, the amount of noise reduction is increased with decreasing transmission data size, thus keeping the image degradation to a minimum.

### (3) Other Embodiment

Although the embodiment described above reduces noise by smoothing of the signal processing section 12, the present invention is not limited thereto but noise may be reduced in the same frame by other technique.

Further, the above described embodiment performs noise reduction in the noise section 15 based on the image data of plural frames along the time axis. However, the present invention is not limited to thereto but may perform noise reduction by the other techniques based on the image data of a plurality of frames on the time axis.

The video signal processing device, method and program according to the present invention are applicable, for example, to a variety of networked camera systems as well as monitoring camera systems.

It should be understood by those skilled in the art that various modifications, combinations, sub-combinations and alterations may occur depending on design requirements and other factor in so far as they are within the scope of the appended claims or the equivalents thereof.

What is claimed is:

1. A video signal processing device for compressing input video and transmitting compressed video data onto a network, the video signal processing device comprising:
compression means for compressing the video; and
noise reduction means for reducing noise in video data by a predetermined amount of noise reduction according to the size of the video data transmitted onto the network.

2. The video signal processing device of claim 1, wherein
the noise reduction means performs noise reduction based on the predetermined number of frames along the time axis commensurate with the number of frames to be reduced if the amount of transmission video data is reduced by reducing the frame rate.

3. The video signal processing device of claim 1, wherein
the compression means and the noise reduction means are included in a single arithmetic device, and
noise reduction by the noise reduction means is performed during a time period when no compression is performed by the compression means.

4. A video signal processing method for compressing input video and transmitting compressed video data onto a network, the video signal processing method comprising the steps of:
compressing the video; and
reducing noise in video data by a predetermined amount of noise reduction according to the size of the video data transmitted onto the network.

5. The video signal processing method of claim 4, wherein
the noise reduction step performs noise reduction based on the predetermined number of frames along the time axis commensurate with the number of frames to be reduced if the amount of transmission video data is reduced by reducing the frame rate.

6. The video signal processing method of claim 4, wherein
the compression step and the noise reduction step are performed by a single arithmetic device, and
noise reduction by the noise reduction step is performed during a time period when no compression is performed by the compression step.

7. A video signal processing program for controlling a video signal processing device, the video signal processing device for compressing input video and transmitting compressed video data onto a network, the video signal processing program causing the video signal processing device to perform the steps of:
compressing the video; and
reducing noise in video data by a predetermined amount of noise reduction according to the size of the video data transmitted onto the network.

8. The video signal processing program of claim 7, wherein
the noise reduction step performs noise reduction based on the predetermined number of frames along the time axis commensurate with the number of frames to be reduced if the amount of transmission video data is reduced by reducing the frame rate.

9. The video signal processing program of claim 7, wherein
the compression step and the noise reduction step are performed by a single arithmetic device, and
noise reduction by the noise reduction step is performed during a time period when no compression is performed by the compression step.

10. A video signal processing device for compressing input video and transmitting compressed video data onto a network, the video signal processing device comprising:
a compression section configured to compress the video; and
a noise reduction section configured to reduce noise in video data by a predetermined amount according to the size of the video data transmitted onto the network.

11. The video signal processing device of claim 10, wherein
the noise reduction section performs noise reduction based on the predetermined number of frames along the time axis commensurate with the number of frames to be reduced if the amount of transmission video data is reduced by reducing the frame rate.

12. The video signal processing device of claim 10, wherein
the compression section and the noise reduction section are included in a single arithmetic device, and
noise reduction by the noise reduction section is performed during a time period when no compression is performed by the compression section.
